(19) United States
(12) Patent Application Publication
(10) Pub. No.: US 2008/0319666 A1
(43) Pub. Date: Dec. 25, 2008

(54) SYSTEM AND METHOD FOR GEO-POSITIONING OF A MOBILE EQUIPMENT

(76) Inventors: ANDREW A. PETROV, BROOKLINE, MA (US); ANDREI A. DOUDKINE, HAVERHILL, MA (US); JOHN A. DARIENZO, STATEN ISLAND, NY (US)

Correspondence Address: AKC PATENTS, 215 GROVE ST., NEWTON, MA, 02466, US

(21) Appl. No.: 12/140,424

(22) Filed: Jun. 17, 2008

Related U.S. Application Data
(60) Provisional application No. 60/945,330, filed on Jun. 20, 2007.

(51) Int. Cl. G01C 21/00

(52) U.S. Cl. 701/213

(57) ABSTRACT

A mobile gateway device collects geo-positioning and status data of a mobile equipment and transmits these data to a remote server via a wireless network and to a local device via a short range communication connection. The communications between the mobile gateway device and the server and between the mobile gateway device and the local device are via reliable guaranteed delivery full-duplex two-way communication channels. The system also includes one or more software applications.

### FIELD OF THE INVENTION

The present invention relates to a system and a method for geo-positioning of a mobile equipment, and more particularly to providing geo-positioning data of a mobile equipment and transmitting these data to a server via a wireless network.

### BACKGROUND OF THE INVENTION

A major component of geo-positioning data is location. Location is usually expressed in terms of geographic coordinates as longitude and latitude and is measured in degrees, seconds, and fractions of the second. Along with coordinates geo-positioning data may include current time, dilution of precision, number of satellites used in a process of coordinates acquisition, method of coordinate calculation, among others. The format for the geo-positioning data and the geo-positioning data acquisition process are defined by data exchange protocols which may vary from one vendor to another. For the purpose of improving compatibility, many vendors utilize industry standard protocols such as NMEA 0183 “NMEA 0183 Standard For Interfacing Marine Electronic Devices”.

One way of collecting location data of a moving object is via a Global Positioning System (GPS) receiver or module. A GPS receiver uses a network of satellites orbiting the earth for collecting and providing location information. GPS satellites broadcast time and position data for each satellite. The GPS receiver identifies each satellite's signal by its distinct Coarse/Acquisition (C/A) code pattern, then measures the time delay for each satellite and calculates the distance to the satellite. Knowing the position and the distance of a satellite indicates that the receiver is located somewhere on the surface of an imaginary sphere centered on that satellite and whose radius is the distance to it. When four satellites are measured simultaneously, the intersection of the four imaginary spheres reveals the location of the GPS receiver.

In many applications it is desirable to be able to transmit geo-positioning data or other type of data of a mobile equipment to a central location. It is also desirable to be able to transmit data from the central location to the mobile equipment.

### SUMMARY OF THE INVENTION

The present invention refers to a system and a method for collecting geo-positioning data and status data of a mobile equipment and transmitting these data to a remote server via a wireless network and to a local device via a short range communication connection.

In general, in one aspect, the invention features a system for determining and transmitting geo-positioning data of a mobile equipment including a gateway device, a server and a client device. The gateway device is configured to be mounted on a first area of the mobile equipment and comprises a sensor for determining geo-positioning data of the mobile equipment and a transmitter for transmitting the determined geo-positioning data via a wireless wide area network (WWAN). The server is located at a first remote location relative to the mobile equipment, and is configured to receive the geo-positioning data from the transmitter via a connection through the wireless wide area network (WWAN) and transmit the geo-positioning data via an Internet network. The client device is located at a second remote location relative to the mobile equipment and relative to the server and is configured to receive the geo-positioning data from the server via a connection through the Internet network.

Implementations of this aspect of the invention may include one or more of the following features. The mobile equipment may be an automobile, bus, train, van, cart, mobile container, boat, truck, trailer, bulldozer, forklift, construction equipment, motorcycle, fire engine, farming equipment, recreation equipment, taxi or other commercial vehicle. The sensor for determining the geo-positioning data comprises a global positioning system (GPS). The mobile equipment area where the gateway device is mounted comprises a rear tail light. The mobile equipment area where the gateway device is mounted comprises a location in the mobile equipment where transmission of short and long range electromagnetic signals is not hindered. The system may further include a mobile communication device configured to communicate with the gateway device via a close proximity network connection. The mobile communication device may be a mobile phone, a personal data assistant, personal computer or laptop computer. The close proximity network may be a wired connection, wireless connection, cable connection, Bluetooth, Infrared, or radio frequency fields. The WWAN may be GSM, GPRS, CDMA, TDMA, 3G, UMTS, WIMAX, CDPD, Mobitex, or HSDPA. The client device may be a personal computer, laptop computer, mobile phone, personal data assistant, or computing circuits. The client device may be used for dispatching data, instructions, information or communications to the gateway device. The gateway device may further include a mobile device status sensor for determining status data of said mobile equipment and then transmitting the determined mobile equipment status data to the server via the transmitter. The mobile device status sensor may be an engine on/off sensor, speed sensor, accelerator sensor, fuel level sensor, oil level sensor, break sensor, gear sensor, road condition sensor, door status sensor, windows status sensor, trunk status sensor, on board safety equipment sensor, cabin temperature sensor, on board entertainment status sensor or on board communication status sensor. The gateway device may further include a microprocessor, a close proximity network transmitter, hardware ID, real time clock, a motion detection switch, lifetime battery, rechargeable battery, battery charger, temperature sensor, battery heater, memory, and a general purpose input output (GPIO) linked to controllable components. The controllable components may be trunk controls, window controls, door controls, engine controls, speed controls, acceleration controls, break controls, gear controls, on board safety equipment controls, cabin temperature controls, on board entertainment controls or on board communications controls. The gateway device and the batteries are configured to operate at below zero temperature environments. The temperature sensor senses the environment temperature and activates the battery heater at temperatures below zero during the recharging of the rechargeable battery. The motion detection switch is configured to turn power on in the gateway device upon sensing of motion of the mobile equipment. The system may further include a mobile application providing instructions for the acquisition of the geo-positioning data and mobile equipment status data. The system may further include a connectivity API, an application connectivity manager, a real-time operating system, a hardware abstract layer, and drivers for the WWAN, the close proximity connection module, GPS, motion detection switch, real-time clock, and GPIO. The mobile application may reside in the gateway device or the mobile communication device. The mobile communication device may further include a MapPoint application, Google Earth application, customized navigation applications, commercial mobile dispatch applications, or mobile administration applications. The communications between the gateway device and the server and between the gateway device and the mobile communication device are via reliable guaranteed delivery full-duplex two-way communication channels.

In general, in another aspect, the invention features a method for determining and transmitting geo-positioning data of a mobile equipment including providing a gateway device configured to be mounted on a first area of the mobile equipment and comprising a sensor for determining geo-positioning data of the mobile equipment and a transmitter for transmitting the determined geo-positioning data via a wireless wide area network (WWAN). Next, providing a server located at a first remote location relative to the mobile equipment, wherein the server is configured to receive the geo-positioning data from the transmitter via a connection through the wireless wide area network (WWAN) and transmit the geo-positioning data via an Internet network. Finally, providing a client device located at a second remote location relative to the mobile equipment and relative to the server and wherein the client device is configured to receive the geo-positioning data from the server via a connection through the Internet network.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1 is an overview diagram of a geo-positioning system;

FIG. 2 is schematic diagram of the mobile gateway hardware components and architecture;

FIG. 3 is a schematic diagram of the mobile gateway software components and architecture; and

FIG. 4 is a schematic diagram of the mobile applications residing in a personal mobile device.

### DETAILED DESCRIPTION OF THE INVENTION

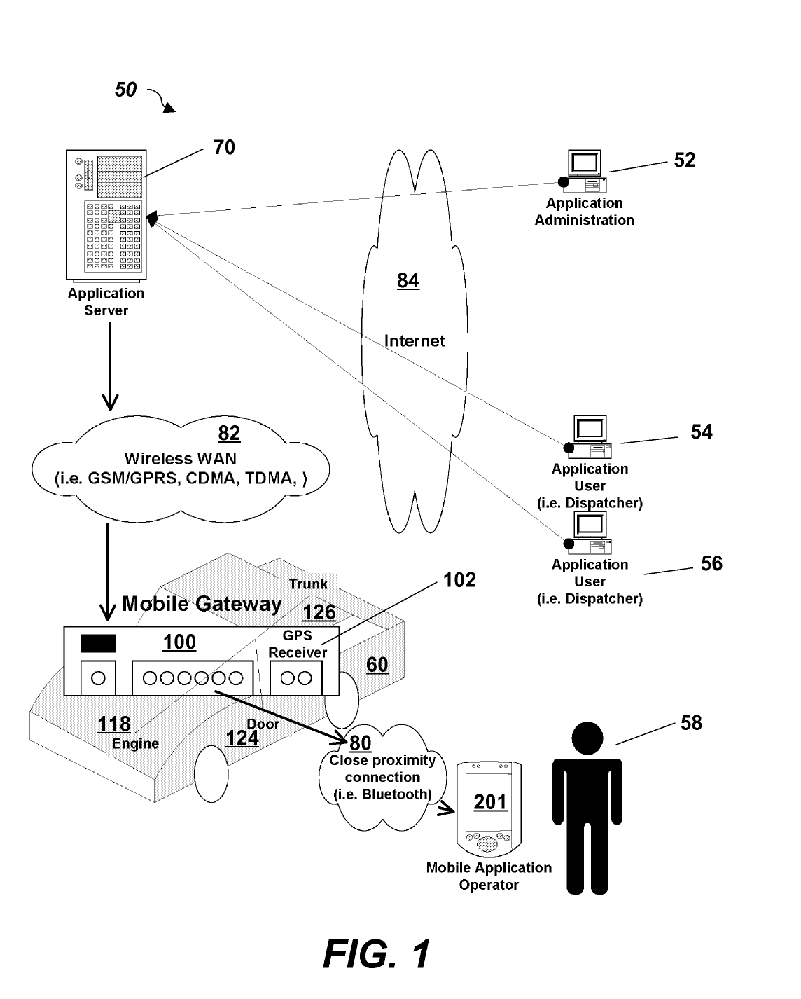

Referring to FIG. 1 a geo-positioning system 50 for a mobile equipment 60 includes a mobile gateway device 100, a personal communication device 201, a server 70 and user devices 52, 54, 56. The mobile gateway device 100 is mounted on the mobile equipment 60. In one example mobile equipment 60 is an automobile having an engine 118, doors 124, trunk 126 headlights and tail lights (not shown). Other examples of mobile equipment include, trucks, buses, trailers, vans, motorcycles, carts, mobile containers, farming or recreation mobile equipment, personal or commercial vehicles, among others. Mobile gateway 100 is mounted in a location of the mobile equipment 60 configured to not interfere with the transmission of short range and long range electromagnetic signals from and to the mobile gateway 100. In one example, the mobile gateway is mounted within the rear tail lights. Mobile gateway 100 communicates via a close proximity connection 80 with a personal communication device 201 carried by a passenger or operator 58 of the mobile equipment 60. The close proximity connection 80 may be wired or wireless. Examples of close proximity connections include a serial cable, Bluetooth, Infrared (IR) and radio frequency (RF) fields. In one example, personal communication device 201 is a personal data assistant (PDA). In other examples, personal communication device 201 is a mobile phone, personal computer, or a personal data device. Mobile gateway 100 also communicates with the server 70 via a wireless wide-area network (WWAN) 82. A WWAN network spans a relatively large geographic area and is used to connect wirelessly mobile portable devices. Examples of WWAN networks include GSM (Global System for Mobile Communications), GPRS (General Packet Radio Service), CDMA (Code Division Multiple Access), TDMA (Time Division Multiple Access), 3G (3^{rd} Generation), UMTS (Universal Mobile Telecommunication System), CDPD (Cellular Digital Packet Data), Mobitex, HSDPA (High Speed Downlink Packet Access), WIMAX (Worldwide Interoperability for Microwave Access), among others. The server 70 is configured to connect to user devices 52, 54, 56 via the Internet 84 and to transmit information and data received from the mobile gateway 100 to the user devices 52, 54, 56. Server 70 may also receive data and information from the user devices 52, 54, 56 to the mobile gateway 100. User devices 52, 54, 56 may be remotely located computers or other communication used for dispatching purposes or administration purposes. Mobile gateway 100 retrieves status data of the mobile equipment, detects if the mobile equipment is moving or if it is stationary, controls the state of the mobile equipment, collects geo-positioning data of the mobile equipment and provides two-way communications with the server 70 and the personal communication device 201.

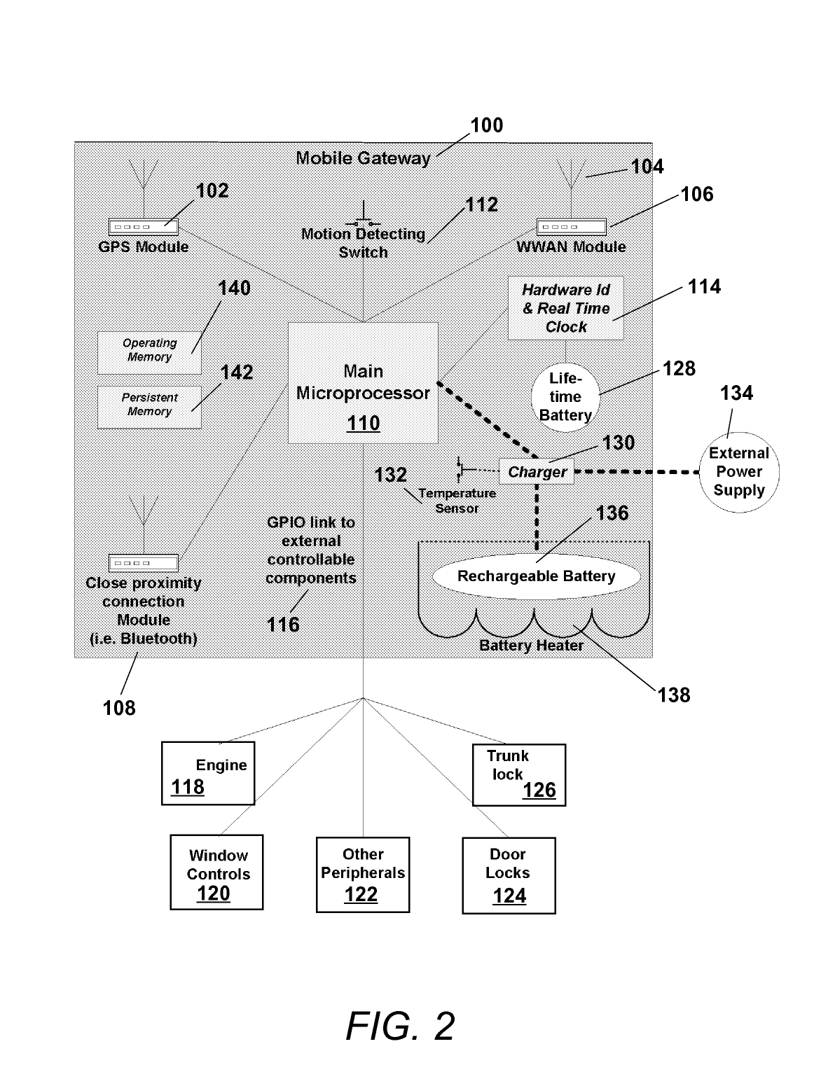

Referring to FIG. 2, mobile gateway 100 includes a main microprocessor 110 connected to a close proximity connection module 108 and antenna 108a, a GPS module 102 and antenna 102a, a wireless WAN module 106 and antenna 104, a hardware id and real time clock 114 and a motion detection switch 112. Main microprocessor 110 controls all hardware components of the mobile gateway 100 and allows execution of the various programs and applications. Mobile gateway may also include a lifetime battery 128, a rechargeable battery 136, a battery charger 130, a temperature sensor 132, a battery heater 138, operating memory 140, persistent memory 142 and a General Purpose Input Output (GPIO) 116 link to controllable components including a trunk lock 126, a door lock 124, a window control 120, engine control 118 and controls to other peripheral components. In one example, the close proximity connection module is a Bluetooth module. Other examples, of close proximity connection modules include serial cable, Infrared module and WiFi communication module. The mobile gateway 100 may be powered by an external power supply 134 directly or by the rechargeable battery 136. The external power supply may also be used to charge the rechargeable battery 136 via the charger 130. The mobile gateway 100 is installed in the mobile equipment and may be operated at environmental temperatures below zero degrees Celsius. Rechargeable battery 130 is capable of operating at temperatures down to minus 40 ° Celsius. However, charging the battery 130 at temperatures below zero degrees Celsius is not feasible. A temperature sensor 132 detects the mobile gateway's temperature and if the temperature is close to or below freezing point a battery heater 138 is turned on to heat the battery during the recharging process. When the sensor detects a battery temperature above zero degrees it shuts off the battery heater 138. Microprocessor 110 detects whether the mobile gateway 00 runs on the external power 134 or the internal power of the rechargeable battery 136 and implements different power saving modes. In one power saving mode the microprocessor 110 chooses to switch power to the mobile gateway completely off in order to consume zero power. The mobile gateway 100 is configured to be awaken by motion. A motion sensor senses the motion of the mobile gateway 100 and triggers the motion detection switch 112 on to turn the power on in the mobile gateway 100. The motion sensor itself does not consume any power due to the fact that it uses a mechanical trigger. Once the motion sensor is triggered the microprocessor is awaken and uses the geo-positioning component 102 to verify whether the mobile equipment 100 actually changed its geo-position. Once the position change is actually detected the device 100 registers this event, stores it in the local persistent storage 142, and communicates the event to the application server 70 and/or to the local mobile application 201. After completing these tasks, the microprocessor 110 measures the power level and makes a determination whether to keep running or switch itself off again.

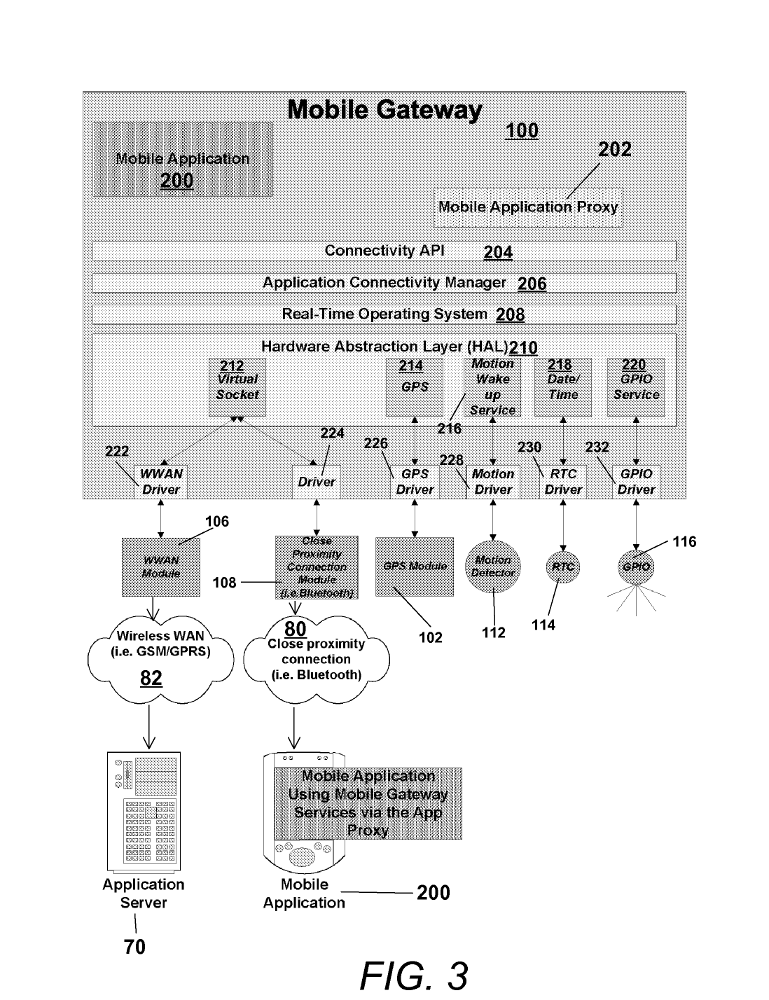

In addition to the above described hardware components, mobile gateway 100 includes firmware components providing instructions for the geo-positioning and status data acquisitions and for managing the above mentioned services and long and short range communications. Referring to FIG. 3, mobile gateway 100 includes a mobile application 200, a connectivity API 204, an application connectivity manager 206, a real-time operating system 208 a hardware abstraction layer 210 and drivers for the WWAN 222, the close proximity connection module 224, GPS 226, motion 228, real time clock (RTC) 230 and GPIO 232. In other embodiments, the mobile application 200 resides in the personal communication device 201. In these cases, the mobile application 200 invokes the mobile gateway's services via a mobile application proxy 202. Mobile application 200 utilizes the mobile gateway services to retrieve geo-positioning data of the mobile equipment 60. It can retrieve status information of the mobile equipment and/or set a signal to the mobile equipment. It also maintains communication with the application server 70 for sending and retrieving data to and from the application server 70. Application server 70 can implement the mobile application's logic on it's own and/or interact with the application administrator 52 and application user 54 or 56 on the server side.

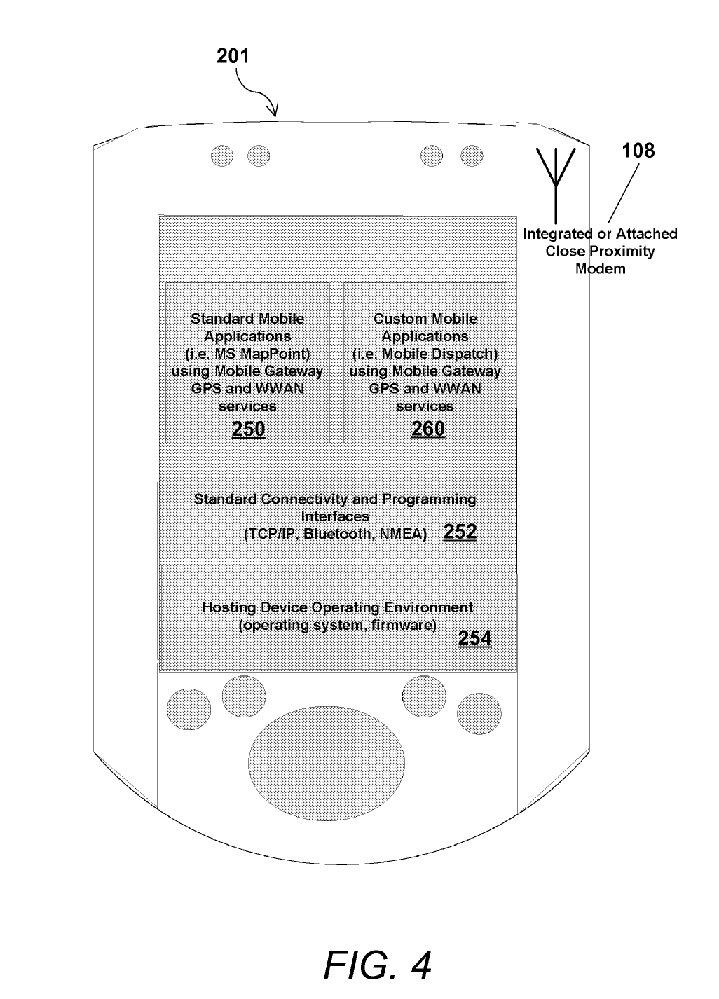

Referring to FIG. 4, the firmware components of the personal communication device 201 include custom mobile applications 260 utilizing the mobile gateway's 100 GPS and WWAN services, standard mobile applications 250 utilizing the mobile gateway's 100 GPS and WWAN services, standard connectivity and programming interfaces 252, operating system and firmware 254 and a close proximity modem 108 and antenna 108a. Examples of standard mobile applications 250 include Microsoft MapPoint and Google Earth. Examples of custom mobile applications 260 include a mobile dispatch application and a mobile administration application. Examples of standard connectivity and programming interfaces include TCP/IP, Bluetooth and National Marine Electronic Association (NMEA). The close proximity modem 108 may be attached or integrated to the device 201.

The geo-positioning location data as well as the mobile equipment status data are consumed at a centralized location (i.e., server, or user devices) monitoring the status and location of the mobile equipment. These same data may also be transmitted and consumed locally in a close proximity to the mobile equipment. In one example, the driver of the mobile equipment uses the geo-positioning data for the purpose of navigation and a remotely located dispatcher uses the same geo-positioning data for the purpose of dispatching instructions to the driver. In other embodiments, the mobile equipment status data and geo-positioning data are collected and transmitted from a stationary equipment. In order to consume geo-positioning location data and mobile equipment status data the operator/driver of the mobile equipment and/or the service personnel/dispatcher need to use an electronic device that has user interface capabilities. Examples of electronic devices with user interface capabilities include devices equipped with a screen, keypad, microphone and speaker. Such user interface devices also have an access to the geo-positioning and status data acquired by the mobile gateway device via any type of a local connectivity feature such as serial line, USB port, Bluetooth wireless connectivity, WI-FI wireless connectivity, among others.

Along with the geo-positioning and mobile equipment status data acquisition the gateway device may also collect and generate data as a result of an operator activity. These data can be generated by the operator or service personnel input and/or by the remotely located personnel fulfilling dispatching and other controlling functions on the server side of the connectivity. For example, a dispatcher may issue an order to a service person that will be delivered from the dispatcher's workstation to the server, then from the server to the gateway device, and then from the gateway device to a service person's Personal Data Assistant (PDA). That same communication path can be used in the opposite direction by the service person accepting a new work-order or notifying the dispatcher about work status. The ability to maintain wireless connectivity between the service person's PDA and the mobile gateway device increases the productivity of the service.

In other embodiments, the mobile gateway device includes additional status sensors for determining additional status data of the mobile equipment and then transmitting the determined mobile equipment status data to the server via the transmitter. The mobile device status sensors may be an engine on/off sensor, speed sensor, accelerator sensor, fuel level sensor, oil level sensor, break sensor, gear sensor, road condition sensor, door status sensor, windows status sensor, trunk status sensor, on board safety equipment sensor, cabin temperature sensor, on board entertainment status sensor or on board communication status sensor. These sensors may also be used to control the corresponding mobile equipment controls, i.e., trunk controls, window controls, door controls, engine controls, speed controls, acceleration controls, break controls, gear controls, on board safety equipment controls, cabin temperature controls, on board entertainment controls or on board communications controls.

Several embodiments of the present invention have been described. Nevertheless, it will be understood that various modifications may be made without departing from the spirit and scope of the invention. Accordingly, other embodiments are within the scope of the following claims.

What is claimed is:

1. A system for determining and transmitting geo-positioning data of a mobile equipment comprising:
a gateway device configured to be mounted on a first area of said mobile equipment and comprising a sensor for determining geo-positioning data of said mobile equipment and a transmitter for transmitting said determined geo-positioning data via a wireless wide area network (WWAN);
a server located at a first remote location relative to said mobile equipment, wherein said server is configured to receive said geo-positioning data from said transmitter via a connection through said wireless wide area network (WWAN) and then transmit said geo-positioning data via an Internet network; and
a client device located at a second remote location relative to said mobile equipment and relative to said server and wherein said client device is configured to receive said geo-positioning data from said server via a connection through said Internet network.

2. The system of claim 1 wherein said mobile equipment comprises one of automobile, bus, train, van, cart, mobile container, boat, truck, trailer, bulldozer, forklift, construction equipment, motorcycle, fire engine, farming equipment, recreation equipment, taxi or other commercial vehicle.

3. The system of claim 1 wherein said sensor for determining geo-positioning data comprises a global positioning system (GPS).

4. The system of claim 1 wherein said mobile equipment area where said gateway device is mounted comprises a rear tail light.

5. The system of claim 1 wherein said mobile equipment area where said gateway device is mounted comprises a location in said mobile equipment where transmission of short and long range electromagnetic signals is not hindered.

6. The system of claim 1 further comprising a mobile communication device configured to communicate with said gateway device via a close proximity network connection.

7. The system of claim 6 wherein said mobile communication device comprises one of a mobile phone, a personal data assistant, personal computer or laptop computer.

8. The system of claim 6 wherein said close proximity network comprises one of wired connection, wireless connection, cable connection, Bluetooth, Infrared, or radio frequency fields.

9. The system of claim 1 wherein said WWAN comprises one of GSM, GPRS, CDMA, TDMA, 3G, UMTS, WIMAX, CDPD, Mobitex, or HSDPA.

10. The system of claim 1 wherein said client device comprises one of personal computer, laptop computer, mobile phone, personal data assistant, or computing circuits.

11. The system of claim 1 wherein said client device dispatches one of data, instructions, information or communications to said gateway device.

12. The system of claim 1 wherein said gateway device further comprises a mobile device status sensor for determining status data of said mobile equipment and wherein said gateway device then transmits said determined mobile equipment status data to said server via said transmitter.

13. The system of claim 12 wherein said mobile device status sensor comprises one of engine on/off sensor, speed sensor, accelerator sensor, fuel level sensor, oil level sensor, break sensor, gear sensor, road condition sensor, door status sensor, windows status sensor, trunk status sensor, on board safety equipment sensor, cabin temperature sensor, on board entertainment status sensor or on board communication status sensor.

14. The system of claim 13 wherein said gateway device further comprises a microprocessor, a close proximity network transmitter, hardware ID, real time clock, a motion detection switch, lifetime battery, rechargeable battery, battery charger, temperature sensor, battery heater, memory, and a general purpose input output (GPIO) linked to controllable components.

15. The system of claim 14 wherein said controllable components comprise one of trunk controls, window controls, door controls, engine controls, speed controls, acceleration controls, break controls, gear controls, on board safety equipment controls, cabin temperature controls, on board entertainment controls or on board communications controls.

16. The system of claim 14 wherein said gateway device and said batteries are configured to operate at below zero temperature environments.

17. The system of claim 16 wherein said temperature sensor senses said environment temperature and activates said battery heater at temperatures below zero during the recharging of said rechargeable battery.

18. The system of claim 17 wherein said motion detection switch is configured to turn power on in said gateway device upon sensing of motion of said mobile equipment.

19. The system of claim 18 further comprising a mobile application providing instructions for the acquisition of the geo-positioning data and mobile equipment status data.

20. The system of claim 19 further comprising a connectivity API, an application connectivity manager, a real-time operating system, a hardware abstract layer, and drivers for the WWAN, the close proximity connection module, GPS, motion detection switch, real-time clock, and GPIO.

21. The system of claim 19 wherein said mobile application resides in one of said gateway device or mobile communication device.

22. The system of claim 21 wherein said mobile communication device further comprises one of MapPoint application, Google Earth application, customized navigation applications, commercial mobile dispatch applications, or mobile administration applications.

23. The system of claim 22 wherein communications between the gateway device and said server and between said gateway device and said mobile communication device are via reliable guaranteed delivery full-duplex two-way communication channels.

24. A method for determining and transmitting geo-positioning data of a mobile equipment comprising:
providing a gateway device configured to be mounted on a first area of said mobile equipment and comprising a sensor for determining geo-positioning data of said mobile equipment and a transmitter for transmitting said determined geo-positioning data via a wireless wide area network (WWAN);
providing a server located at a first remote location relative to said mobile equipment, wherein said server is configured to receive said geo-positioning data from said transmitter via a connection through said wireless wide area network (WWAN) and transmit said geo-positioning data via an Internet network; and
providing a client device located at a second remote location relative to said mobile equipment and relative to said server and wherein said client device is configured to receive said geo-positioning data from said server via a connection through said Internet network.
